(19) United States
(12) Patent Application Publication
(10) Pub. No.: US 2015/0287066 A1
(43) Pub. Date: Oct. 8, 2015

(54) AFFILIATE MARKETING SYSTEM: METHOD AND APPARATUS

(71) Applicants: William Don Wortley, Minneapolis, MN (US); Ryan Diehl, St. Paul, MN (US); Alan Heuring, Plymouth, MN (US); Matthew Johnson, Minneapolis, MN (US)

(72) Inventors: William Don Wortley, Minneapolis, MN (US); Ryan Diehl, St. Paul, MN (US); Alan Heuring, Plymouth, MN (US); Matthew Johnson, Minneapolis, MN (US)

(73) Assignee: BBY SOLUTIONS, INC., Richfield, MN (US)

(21) Appl. No.: 14/247,695

(22) Filed: Apr. 8, 2014

(51) Int. Cl. G06Q 30/02; G06Q 20/20

(52) U.S. Cl. CPC G06Q 30/0222; G06Q 20/20

(57) ABSTRACT

The present invention is a method and system for marketing by an affiliate of a retailer using electronic coupons. Data in the electronic coupon may include an affiliate ID, a consumer ID, and an offer to discount one or more products from the retailer. The electronic coupon is accessed by the retailer, either through a point-of-sale system in a store, by accessing information on a mobile device of the consumer, or online. A commission is applied by a processing system to products purchased during the transaction, but the affiliate is responsible to reimburse the retailer for the amount of any discount attributable to the coupon that would otherwise financially impact the retailer.

### FIELD OF THE INVENTION

The present invention relates to a marketing system whereby an affiliate is rewarded for encouraging consumers to purchase from a retailer.

### SUMMARY OF THE INVENTION

An affiliate marketing system with a point-of-sale (POS) interaction is described. The affiliate provides an e-coupon to a consumer. This transfer might be done electronically, and the coupon may be stored in nonvolatile storage on a mobile electronic device of the consumer, such as a smart phone, a smart watch or other wearable smart device, a portable media player, an e-reader, a small notebook computer, or a tablet computer. The e-coupon includes an affiliate identifier (ID), a consumer ID, and an offer. The e-coupon might also include a retailer ID, which identifies a particular store or a chain of stores where the consumer may redeem the coupon. The coupon might also include a means for authenticating the validity of the e-coupon. The e-coupon might be read or scanned by a point-of-sale system in a store. The format for the contents of the e-coupon might be a bar code, a two-dimensional bar code, or any other representation of information that could be read or scanned from the portable electronic device. A representation of the e-coupon might be scanned from an image displayed on a screen of the mobile device.

The offer may provide a discount on one or more products (i.e., goods or services). When the retailer redeems the offer for the consumer, the retailer notes the total amount of purchases made during the sale transaction. The retailer then provides the affiliate with a commission based on the total sale amount of the transaction in which the consumer uses the coupon, minus any discount amount. Calculation of the commission may use a rate that is a percentage or fraction R, such that 0<R<1. Depending upon embodiment, the “total sale amount” to which the rate is applied in calculating the commission might or might not include the discounted product(s). Note that the commission might actually be negative, meaning that the affiliate must reimburse the retailer for some or all of the discount to this consumer. This accountability is an incentive for the affiliate to be selective in making offers, encouraging certain classes of consumers, ones who are not solely bargain-shoppers, to visit the retailer.

An offer might include one or more incentives to the consumer from the affiliate, other than discounts on the retailer's products. For example, the affiliate might allow the consumer to download some digital material, redeem an award at some other retailer (e.g., for an online music download), or to attend some event. If, and to the extent, that such an incentive would not impact the retailer financially, then the value of the incentive will not be considered to be part of the discount amount.

The affiliate ID allows the retailer to know which affiliate, among a set of affiliates, has made the offer, and is entitled to the commission. The consumer ID informs the affiliate of the identities of those consumers, to whom the offer was made, who took advantage of the coupon. The retailer ID informs the retailer that the offer made by the affiliate to this consumer was intended to be used for purchases from this retailer.

In general, the relationship created by such e-coupons between affiliates and consumers, may be many-to-many; the relationship between consumers and retailers may be many-to-many. And the relationship between retailers and affiliates may be many-to-many. Of course, simpler relationships may be possible. At the opposite extreme, a single affiliate may issue such e-coupons, to a single consumer, for use at a single retailer; in this case, all relationships are one-to-one. Any combinations of one-to-one, many-to-one, and many-to-many relationships, created by such e-coupons, are possible. In more multifaceted schemes, a central broker to manage multiple relationships created by such e-coupons may be beneficial.

Some embodiments of the method of the invention comprise: during a sales transaction at a retailer, wirelessly receiving from a mobile electronic device through a physical interface of a point-of-sale system an electronic coupon whose contents include a consumer identifier (ID) that identifies a consumer, an affiliate ID that identifies an affiliate of the retailer, and an offer pertaining to the retailer and one or more products covered by the coupon, where any goods and services provided by the retailer (as opposed to the affiliate) are considered products; applying the coupon, thereby reducing the cost to the consumer of covered products sold to the consumer by a discount amount D; calculating by a processing system a total amount TA received from the consumer for products sold to the consumer during the transaction; recording D, by the processing system, in nontransitory computer-readable storage; calculating by the processing system a commission amount C applicable to the sales transaction, wherein the commission amount is equal to TA*R minus D, and R is a fraction or percentage; and transmitting, by the processing system through a physical network interface, an accounting, directed to the affiliate, which includes the commission amount.

In some embodiments, a e-coupon from the affiliate might offer the consumer award points (e.g., airline award points or credit card award points), digital goods, or other incentives, either in addition to, or in lieu of, a discount on products from the retailer. To the extent those awards, goods, or incentives are provided, as a reward to the consumer for visiting the retailer, by the affiliate, rather than by the retailer, then they do not contribute to the discount D. Indeed, D might be zero.

Some embodiments of the method of the invention comprise: transmitting wirelessly, by a processing system of an affiliate of a retailer and through a physical interface, an electronic coupon, directed to a mobile electronic device, the contents of the electronic coupon including a consumer identifier (ID), identifying a consumer associated with the mobile electronic device, an affiliate ID, identifying the affiliate, and an offer pertaining to a retailer and to one or more products covered by the coupon, where goods and services are considered products; and receiving by the processing system through a physical network interface, an accounting from the retailer, which includes a commission amount pertaining to a sales transaction in which the consumer applied the coupon to at least one covered product, wherein the commission amount is equal to a percentage of a total sales amount of the transaction, minus a total discount amount due to application of the coupon.

### BRIEF DESCRIPTION OF THE DRAWINGS

FIG. 1 is a conceptual diagram illustrating an exemplary affiliate marketing system from the perspective of a consumer.

FIG. 2 is a conceptual diagram illustrating an exemplary affiliate marketing system from the perspective of a retailer or an affiliate.

FIG. 3 is a diagram illustrating the contents of an exemplary e-coupon.

FIG. 4 is a flowchart illustrating an exemplary issuance of an e-coupon by an affiliate, redemption of the e-coupon by a consumer from a retailer, and payment of commission by the retailer to the affiliate, or by the affiliate to the retailer.

FIG. 5 is a diagram illustrating exemplary data, stored in nonvolatile storage, which pertains to a retailer.

FIG. 6 is a diagram illustrating exemplary data, stored in nonvolatile storage, which pertains to a consumer.

FIG. 7 is a diagram illustrating exemplary data, stored in nonvolatile storage, which pertains to an affiliate.

FIG. 8 is a conceptual diagram illustrating a broker managing interactions among participants in an exemplary affiliate marketing system.

### DETAILED DESCRIPTION OF EXEMPLARY EMBODIMENTS

This description provides embodiments of the invention intended as exemplary applications. The reader of ordinary skill in the art will realize that the invention has broader scope than the particular examples described here. It should be noted from the outset that the drawings, and the elements depicted by the drawings, are not to scale.

In this description and claims, the verb “to store” means to store in tangible nontransitory computer-readable storage. By “storage” we mean tangible nontransitory computer-readable storage. By “download”, we mean download from a remote system using a wireless communication system; the communication system might be the Internet or some other system or combination of systems. By the word “computer”, we mean any laptop computer, desktop computer, tablet computer, smart phone, portable media device, wearable smart device, or any other electronic device capable of executing consumer software applications. By “data”, we mean information stored in, or accessed from, storage. By “database”, we mean a collection of somehow-interrelated data. By the word “or” we mean “inclusive or”, unless it is clear from the context that “exclusive or” is intended; so “A or B” means A, B, or A and B. By “logic”, we mean hardware, and software instructions, accessed from storage, that execute upon hardware under control of a computer processor.

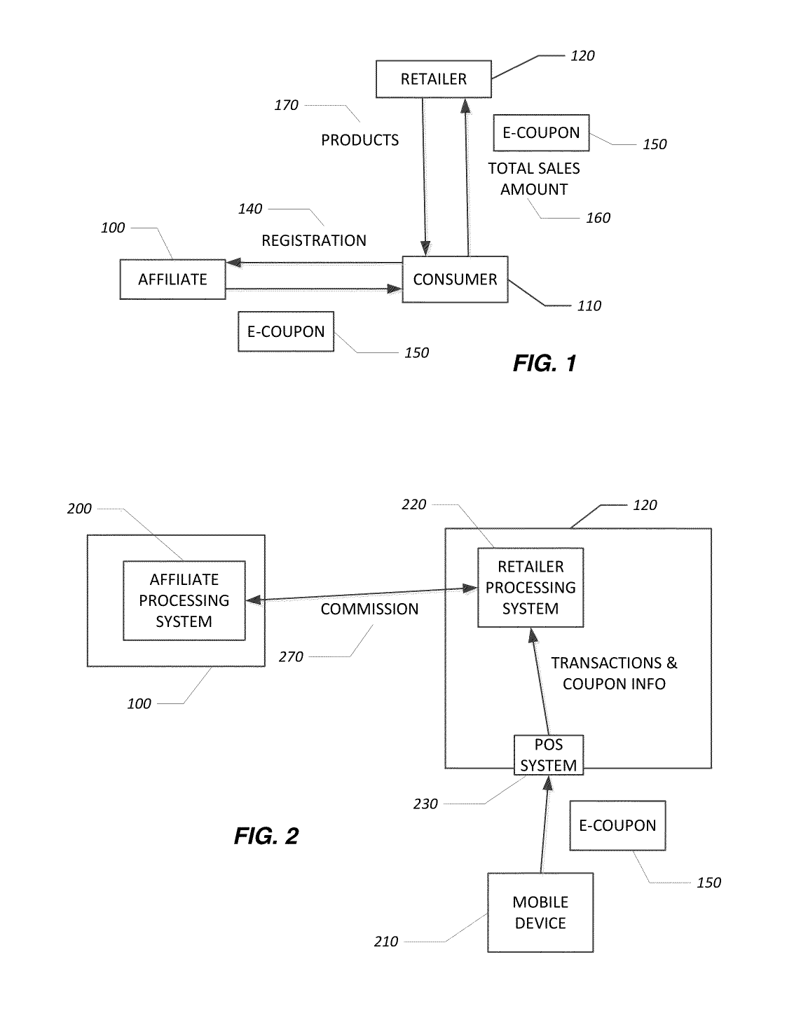

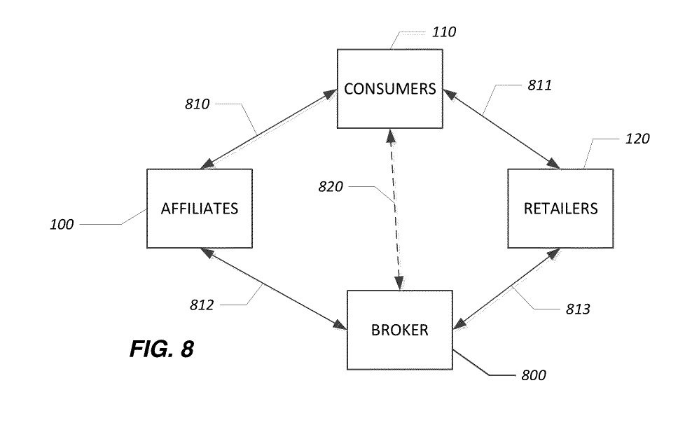

FIG. 1 is a conceptual diagram illustrating an exemplary affiliate marketing system from the perspective of a consumer 110. The consumer 110 registers with an affiliate 100, and the registration entitles the consumer 110 to receive e-coupons 150. Such registration may occur by any process whereby the consumer 110 agrees to receive, or requests, e-coupons 150. For example, the consumer 110 might download and license an application (app) from the affiliate 100, or sign up at a website. The registration need not be directly with the affiliate 100. For example, a retailer 120 or a broker 800 (discussed in connection with FIG. 8) might offer to provide the consumer 110 with e-coupons 150.

Note that in some embodiments, no registration at all might be required for a consumer 110 to get an e-coupon 150. The consumer 110 might simply access the offer for an e-coupon 150 from the affiliate 100, or the affiliate 100 might simply provide the offer to the consumer 110 in any of the many means available for transmitting information electronically.

In some embodiments of the invention, the affiliate 100 provides e-coupons 150 to a mobile electronic device 210 of the consumer 110. The e-coupon 150 is specific a retailer 120, and has the goal of bringing business to a brick-and-mortar store of that retailer 120. The consumer 110 presents the e-coupon 150 to the retailer 120. The retailer 120 may read information from the mobile device 210 with its point-of-sale (POS) system 230 by any means. For example, the consumer 110 might execute an app from the affiliate 100 that accesses the e-coupon 150 and presents its information in a form that can be scanned by a reader of the POS system 230. The e-coupon might be read or scanned by a point-of-sale system in a store. The format for the contents of the e-coupon might be a bar code, a two-dimensional (2D) bar code, or any other representation of information that could be read or scanned from the mobile device 210. Presentation of the information by the mobile device 210 might use an app that is not dedicated to the affiliate-marketing system. A 2D bar code might be presented by a simple app that accesses a directory of photographic images, which includes an image showing the bar code. The contents of the e-coupon 150 itself might be stored on the mobile device 210. Alternatively, the e-coupon 150 might be identified by an identification (ID) number that is stored on the mobile device 210. In this case, the contents of the e-coupon 150 might be downloaded to the mobile device 210, or directly to the POS system 230 at the time of scanning. Any process for transferring the information from the e-coupon 150 to the retailer 120 is within the inventive scope.

In some embodiments of the invention, the affiliate 100 provides e-coupons 150 to any computer (see above definition) of the consumer 110. Redemption of an e-coupon 150 might be done by the consumer 110 at an on-line retailer. The contents of the e-coupon 150 might be stored on the computer, or only an ID of the e-coupon 150 might be stored. In the latter case, the e-coupon 150 might then be received by the online retailer 120 from that computer, or from some other online source using the ID of the e-coupon 150, such as a server of the affiliate 100 or a broker 800.

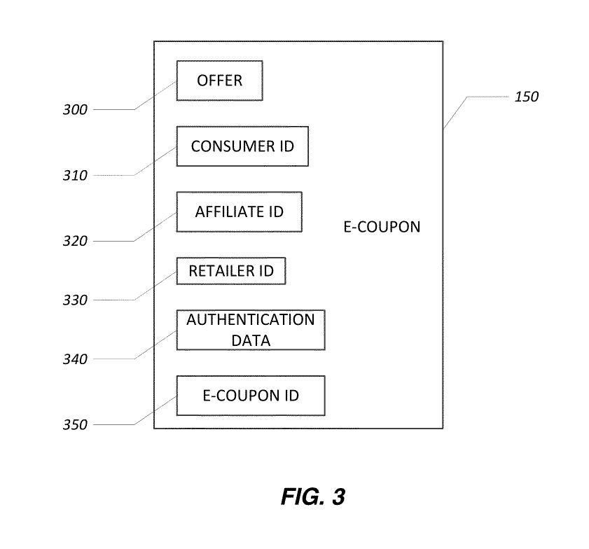

The data contents of an exemplary e-coupon 150, represented in storage, are shown in FIG. 3. The e-coupon 150 contains an offer, defining a discount. The discount offer can be of any type, such as a percentage reduction, two-for-one, a specified price below retail, and so forth. The discount offer might apply to a specific product model or SKU (e.g., a specific brand and model of smart phone) or to a class of products (e.g., any smart phone). The discount offer might apply to allow the consumer 110 to buy more than one products (e.g., limit 5 quarts of ice cream), or require the consumer 110 to buy a combination of products (e.g., a dishwasher with a service plan). The e-coupon 150 might only include an offer ID, rather than the details of the offer. An offer ID might suffice to define the offer for the retailer 120 or for the affiliate 100, since the details might be accessed from storage.

The e-coupon 150 specifies a consumer ID 310. The consumer ID 310 may be used when authenticating that this consumer 110 is entitled to use the e-coupon 150. The affiliate 100 or the retailer 120 might to want market to specific groups of consumers 110. Such targeting might be based, for example, upon loyalty, predicted buying habits, demographics, or actual or desired interests of the particular consumer 110 or class of consumers 110. Thus, the number of consumers 110 receiving a particular e-coupon 150 might range from one to many.

The affiliate ID 320 and the retailer ID 330 are used to settle a commission 270 between the affiliate 100 and the retailer 120 arising from redemption of the e-coupon 150. The e-coupon 150 may specify an affiliate ID 320. But if the retailer 120 has a single affiliate 100 providing e-coupons 150, the affiliate ID 320 may be superfluous, and not be provided. If many affiliates 100 use e-coupons 150 to market for this retailer 120, or if a broker 800 is involved, an affiliate ID 320 may be present. The e-coupon 150 may specify a retailer ID 330. But if the affiliate 100 provides e-coupons 150 to a single retailer 120, the retailer ID 330 may be superfluous, and not be provided. If an affiliate 100 markets for many retailers 120, or if a broker 800 is involved, a retailer ID 330 may be included in the e-coupon 150 data. If the e-coupon 150 is only redeemable at a specific store or set of stores of the retailer 120, then an identifier (not shown) might also be included in the e-coupon 150 to specify such limitation.

The retailer 120 might want to verify that the e-coupon 150 being presented for redemption is valid. Various types of authentication are possible. For example, the retailer 120 might check whether it has an e-coupon 150 marketing contract with this affiliate 100, or more specifically, whether this affiliate 100 is authorized to issue such an e-coupon 150. It may check for compliance of the e-coupon 150 with its own e-coupon 150 restrictions (e.g., on product type, size of discount, or offer start and end dates), or similar restrictions of the affiliate 100. The retailer 120 might check a database to see whether the affiliate 100 has given the e-coupon 150 to this particular consumer 110, as identified by the consumer ID 310. This database might be a database of the retailer 120, or might be remotely accessed from the affiliate 100. The e-coupon 150 might include authentication data 340. For example, the authentication data 340 might be an encrypted date (or date-time) of e-coupon 150 issue, and the consumer 110 might have been required to redeem the e-coupon 150 by that date, or within so many hours/days after that date. Alternatively, the authentication data 340 might be, for example, an encrypted version of a unique hardware ID associated with the mobile electronic device 210 presented by the consumer 110 for redemption; the encrypted version could then be decrypted and compared with the actual unique hardware ID of the device. Many forms of authentication are possible, with or without an explicit authentication data 340 field in the e-coupon 150 data. A retail processing system 220 might perform such authentication before allowing the sales transaction to proceed. Executing logic to perform authentication might involve an affiliate processing system 200 as well as the retail processing system 220, and access to one or more databases on either such system.

The e-coupon 150 might include an e-coupon ID 350. The e-coupon ID 350 might be used, for example, to retrieve other data elements from storage. The e-coupon 150 might be used for authentication; for example, the retailer 120 might only allow an e-coupon 150 with a given e-coupon ID 350 to be used once. An e-coupon ID 350 might or might not be encrypted. Contents of an e-coupon ID 350 might be required for authentication purposes to satisfy certain formatting or checksum requirements.

FIG. 2 is a conceptual diagram illustrating an exemplary affiliate marketing system from the perspective of a retailer 120 or an affiliate 100. When the consumer 110 redeems an e-coupon 150 (in the embodiment shown, this is done at a POS system 230, but as mentioned previously, it might be done online), the retailer 120 may store, in a retail processing system 220, information needed (if any) to identify the affiliate 100; the total discount applied due to the e-coupon 150; and the total amount spent by the consumer 110 in the transaction that included the redemption. The retailer 120 may also store the undiscounted price of the e-coupon 150-discounted product(s), or the total sales amount of the products sold that were not e-coupon 150-discounted. The retailer 120 may store any or all of the data items in the e-coupon 150, or possibly just an e-coupon ID 350.

Using the retail processing system 220, which includes a processor, logic, and storage, the retailer 120 may calculate a commission 270 based on the e-coupon 150. Alternatively, such calculation may be performed by the affiliate 100 or by a broker 800. Calculation of commission 270 due may be done on an aggregate basis (e.g., aggregating all e-coupon 150 redemptions for this affiliate 100 within a given period, such as a month). In any case, the commission 270 attributable to a single e-coupon 150 redemption may be positive or negative, as indicated by the double-ended commission 270 arrow in FIG. 2. The amount of the commission 270 may be transferred automatically from the retail processing system 220 to an affiliate processing system 200, or conversely. The actual transfer of money may be done in any of various known means, such as a direct bank deposit.

Let D be the total amount saved by the consumer 110 by redemption of the e-coupon 150, to the extent that the retailer 120 is responsible for that saving. If the affiliate 100 is responsible financially for some reward given to the consumer 110 through the e-coupon 150 as an incentive for shopping at a store of the retailer 120, then that reward does not figure into the calculation of D. Depending upon the mix of reward types that the consumer 110 redeems, D might be nonzero. Let T be the total sale amount of all products bought in the sales transaction when the consumer 110 redeems the e-coupon 150 with the retailer 120. Let TD be the total price of the discounted products, without the discount, and let TO (T-other)=T−TD. Then two possible formulas for the commission 270 are C=T*R−D and C=TO*R−D.

Note that, under either formula, the commission 270 might be negative. In this case, the affiliate 100 owes commission 270 to the retailer 120. Thus, the affiliate 100 is best rewarded by driving to the retailer 120 those consumers 110 who purchase products in addition to products discounted by the e-coupon 150. In general, the invention encompasses any formulation for commission 270 in which the affiliate 100 is penalized for a consumer 110 who buys only the product(s) discounted by the e-coupon 150.

If the commission 270 can be negative, a retailer 120 may be motivated to give its affiliates 100 more flexibility. For example, the retailer 120 might allow an affiliate 100 (or indeed, all its affiliates 100) to make virtually any offer the affiliate 100 wants, possibly within limits or rules imposed by the retailer 120. A wise affiliate 100 will research buying indicia 630 of the consumers 110 to whom it makes an offer 300.

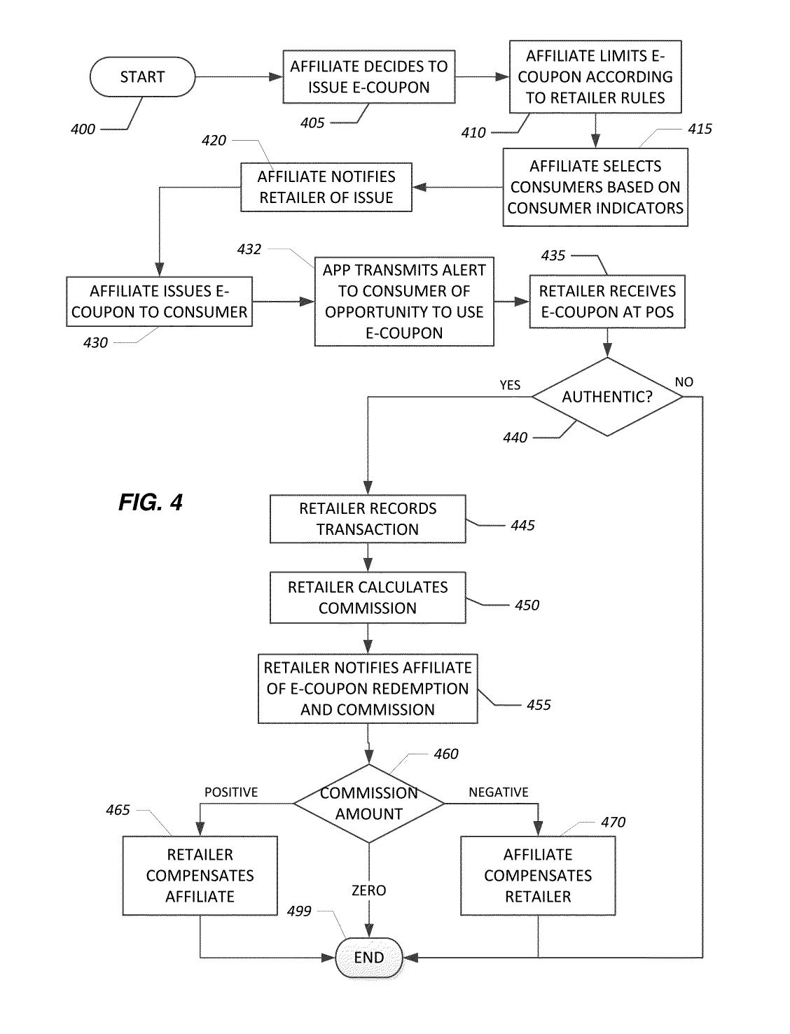

FIG. 4 is a flowchart illustrating an exemplary issuance of an e-coupon 150 by an affiliate 100, redemption of the e-coupon 150 by a consumer 110 from a retailer 120, and payment of commission 270 by the retailer 120 to the affiliate 100, or by the affiliate 100 to the retailer 120. After the start 400, the affiliate 100 decides 405 to issue an e-coupon 150. The affiliate 100 limits 410 the terms of the e-coupon 150 to conform at least to any retailer offer limits 530, but also possibly to its own affiliate offer limits 730. The information to perform these checks is in storage of the affiliate processing system 200, or of the retail processing system 220 and accessible to the affiliate 100. The affiliate 100 may select 415 those consumers 110 to receive the e-coupon 150 based upon buying indicia 630. In this example, the affiliate 100 alerts 420 the retailer 120 of the issue of the e-coupon 150. The consumer 110 is notified 432, or reminded, of the e-coupon 150, near to or inside the retail establishment. The affiliate 100 issues 430 the e-coupon 150 to a consumer 110. The retailer 120 receives 435 the e-coupon 150 from the consumer 110 through the POS system 230.

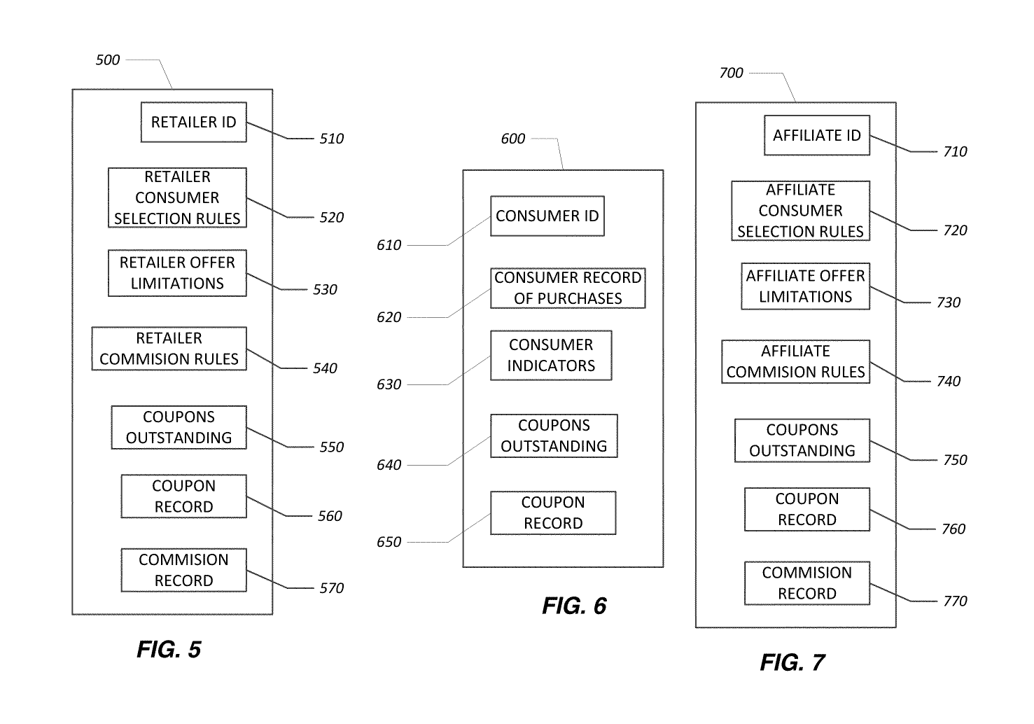

This authentication might involve a check by the retailer 120 with the affiliate 100 for validity of the e-coupon 150. Such a check might be performed automatically between the retail processing system 220 and the affiliate processing system 200 using any or all of the information contained therein, as well as any data stored by the retailer 120 or the affiliate 100, as described in relationship to FIG. 5-7. In particular, authenticating validity of the electronic coupon might include transmitting by the retail processing system 220 a request for authentication (along with information from the e-coupon 150), directed to the affiliate, through a physical interface of a POS system 230, and receiving at the POS system 230 an authentication of validity. From the standpoint of the affiliate 100, authentication might involve receiving a request for validation by the affiliate processing system 200; checking the contents of the e-coupon 150 for validity, and then authenticating validity by transmitting a response directed to the POS system 230, or more generally, to the retail processing system 220. The entire validation process might be required to be completed, in near-real time while the consumer 110 waits at the POS system 230, before the POS system 230 allows the e-coupon 150 to be redeemed.

If the retailer 120 authenticates 440 and accepts the e-coupon 150, the process continues, and the e-coupon is redeemed; otherwise, the process ends, and the e-coupon 150 will not be applied to the purchase. The retailer 120 records 445 various aspects of the transaction, at least data sufficient to be able to calculate 450 the associated commission 270. Through its retail processing system 220, the retailer 120 notifies 455 the affiliate 100 of redemption of the e-coupon 150 and the commission 270. If 460 the commission 270 amount is positive, the retailer 120 pays 465 the affiliate 100; and if negative, the affiliate 100 pays 470 the retailer 120. The process ends 499.

In some embodiments, the order of performing the steps might be different; some steps might be omitted; or other steps might be added. As mentioned previously, for example, an affiliate 100 might provide an e-coupon 150 that includes incentives for a consumer 110 to shop at a store of the retailer 120, other than discounts on products from the retailer 120 itself. For example, the e-coupon 150 might give some kind of rewards points to the consumer 110, for which the affiliate 100 is ultimately responsible, or a gift card for a restaurant. For example, an affiliate 100 might award points if a consumer 110 goes to the store, if the consumer 110 runs a product through some kind of scanner at the store to evidence that they examined the product, and if they purchase a product—all at no cost to the retailer 120. If, and to the extent, that the retailer 120 is not financially responsible for some incentive, then that incentive does not detract from the commission amount due from the retailer 120 to the affiliate 100.

The step of alerting 420 the consumer 110 might be done in various ways. An app might be running in background on their mobile device 210. In some embodiments, the app might be obtained from the affiliate 100; in others, it might be obtained from the retailer 120. The app might become aware that the consumer 110 is in or near a store for which an e-coupon 150 is available. The awareness could come by determining the location of the device by any detection technology, such as GPS, cell phone towers, beacons, or RFID systems in or near the store. When the consumer 110 is found to be within some area including the store, the app might send an alert to the mobile device 210. The alert might be audible, visible, or tangible (e.g., vibration), or some combination thereof.

Alternatively, the consumer 110 might be aware of their e-coupons 150, and simply initiate execution of a coupon app when they enter the store, which will inform them of any relevant e-coupons 150. In some embodiments, a consumer 110 might be issued an e-coupon 150 for the first time when they are inside a store as a reward for being there, or when they are in the neighborhood of a store as an encouragement to drop in.

FIG. 5-7 illustrate exemplary data, some or all of which might be stored by an affiliate 100 in one or more databases. (Of course, databases of the affiliate 100 or of the retailer 120 might also include software logic that processes any of such data as described herein.) FIG. 5 shows retailer data 500; the affiliate 100 may maintain such data for one or more retailer 120. The FIG. 5 might include a retailer ID 330; retailer selection rules 520, which govern to which consumers 110 the retailer 120 allows the affiliate 100 to provide e-coupons 150, and under which circumstances; retailer offer limits 530, which limit the kinds of offers 300 that the retailer 120 will accept, or specifies which particular offers 300 will be acceptable; coupons outstanding 550, which might include any value outstanding for particular e-coupons 150 or total e-coupons 150 with this retailer 120; and a retailer commission record 570, which might include a record of total commission 270 received from this retailer 120.

FIG. 6 shows consumer data 600 that an affiliate 100 might maintain about one or more consumers 110. The consumer data 600 might include a consumer ID 310; consumer purchase records 620 pertaining to one or more retailers 120; buying indicia 630 that might indicate how this consumer 110 might respond to a particular e-coupon 150; consumer coupons outstanding 640, possibly by retailer 120; and consumer coupon record 650, giving a track record of purchases by consumer 110 characteristics.

FIG. 7 shows consumer data 600 that an affiliate 100 might maintain about itself, or if available, other affiliates 100. The affiliate data 700 might include an affiliate ID 320; affiliate selection rules 720, which characterize how the affiliate 100 selects consumer 110 to whom to give an e-coupon 150; affiliate offer limits 730, which govern the types of e-coupons 150 that might be offered, for example, to a maximum amount; affiliate commission rules 740, which govern what kinds of commission 270 arrangements that the affiliate 100 is willing to make with retailers 120; affiliate coupons outstanding 750, which is a record of outstanding e-coupons 150 of the affiliate 100; affiliate coupon record 760, which is a historical record for the affiliate 100 of e-coupons 150 issued; and affiliate commission record 770, which is a record of commission 270 from e-coupons 150.

Some or all of the data shown in FIG. 5-7 might be stored by a retailer 120, either alternatively or in addition to the databases of the affiliate 100. The initial trigger for issuing an e-coupon 150 might come from either the affiliate 100 or the retailer 120. If the idea comes from the retailer 120, only one or several of its affiliates 100 might be invited to participate. Presumably, if both the retailer 120 and the affiliate 100 have consumer selection rules, offer limitations, or commission rules, both the retailer 120 constraints and the affiliate 100 constraints will have to be satisfied. The rules and policies between a retailer 120 and an affiliate 100 may be formalized in one or more contracts, some form of which may be included in storage or automatically enforced by the processing systems involve. Note that all the logic for calculations and data management and rules enforcement can be performed by either the retail processing system 220 or the affiliate processing system 200, or any combination thereof.

FIG. 8 envisions an embodiment in which a broker 800 acts as an intermediary between one or more affiliates 100 and one or more retailers 120. The broker 800 might maintain some or all of the data shown in FIG. 5-6 on behalf of affiliates 100, retailers 120, or both. The broker 800 might respond to requests from an affiliate 100 or a retailer 120, for example, to distribute an e-coupon 150 or to specify some rule or limit. The broker 800 might do consumer research and targeted marketing on behalf of the affiliates 100 or the retailers 120. The broker 800 might do commission accounting among the participants. Interaction between the broker 800 and affiliates 100 is two-way, as indicated by arrow 812; similarly, for interaction between the broker 800 and the retailers 120, indicated by arrow 813. All interaction with the consumers 110 might be done by the affiliates 100 and the retailers 120 (arrows 810 and 811), but possibly the broker 800 might interact directly with the consumers 110 (dashed arrow 820), distributing e-coupons 150 to them from one or more affiliates 100 or one or more retailers 120.

Of course, many variations of the above method are possible within the scope of the invention. The present invention is, therefore, not limited to all the above details, as modifications and variations may be made without departing from the intent or scope of the invention. Consequently, the invention should be limited only by the following claims and equivalent constructions.

What is claimed is:

1. A method, comprising:
a) during a sales transaction at a retailer, wirelessly receiving from a mobile electronic device through a physical interface of a point-of-sale system an electronic coupon whose contents include
(i) a consumer identifier (ID), identifying a consumer,
(ii) an affiliate ID, identifying an affiliate of the retailer, and
(iii) an offer pertaining to the retailer and one or more products covered by the coupon, where goods and services are considered products;
b) applying the coupon, thereby reducing the cost to the consumer of covered products sold by the retailer to the consumer by a discount amount D;
c) calculating by a processing system a total amount TA received from the consumer for products sold to the consumer during the transaction;
d) recording D, by the processing system, in nontransitory computer-readable storage;
e) calculating by the processing system a commission amount C applicable to the sales transaction, wherein the commission amount is equal to TA*R minus D, and R is a fraction or percentage, where 0<R<1; and
f) transmitting, by the processing system through a physical network interface, an accounting, directed to the affiliate, which includes the commission amount.

2. The method of claim 1, wherein C is negative.

3. The method of claim 1, wherein TA is equal to the total sales amount for all products purchased during the transaction, including any covered products.

4. The method of claim 1, wherein TA is equal to the total sales amount for all products purchased during the transaction, excluding any covered products.

5. The method of claim 1, further comprising:
g) transmitting an alert, directed to a mobile electronic device of the consumer when the consumer is determined to be in or near a store, that the consumer has a coupon pertaining to a product available from the store.

6. The method of claim 1, wherein receiving the electronic coupon includes scanning a bar code displayed on a screen of the mobile electronic device.

7. The method of claim 6, wherein the bar code is a two-dimensional bar code.

8. The method of claim 1, further comprising:
g) storing the electronic coupon contents, D, and TA in the storage.

9. The method of claim 1, further comprising:
g) authenticating validity of the electronic coupon.

10. The method of claim 1, wherein authenticating validity of the electronic coupon includes transmitting by the processing system a request for authentication, directed to the affiliate, through a physical interface of the point-of-sale system, and receiving at the point-of-sale system an indication of whether the coupon is valid, and only performing steps b through f if the indication authenticates validity.

11. The method of claim 9, wherein authenticating involves comparing the consumer ID with a unique identifier of the mobile electronic device.

12. The method of claim 1, wherein contents of the electronic coupon further include
(iv) a retailer ID, identifying the retailer.

13. The method of claim 1, wherein the discount amount D does not include a value of an incentive in the offer, wherein the incentive does not have a financial impact upon the retailer.

14. A method, comprising:
a) transmitting wirelessly, by a processing system of an affiliate of a retailer and through a physical interface, an electronic coupon, directed to a mobile electronic device, the contents of the electronic coupon including
(i) a consumer identifier (ID), identifying a consumer associated with the mobile electronic device,
(ii) an affiliate ID, identifying the affiliate, and
(iii) an offer pertaining to a retailer and to one or more products covered by the coupon, where goods and services are considered products; and
b) receiving by the processing system through a physical network interface, an accounting from the retailer, which includes a commission amount pertaining to a sales transaction in which the consumer applied the coupon to at least one covered product, wherein the commission amount is equal to a percentage of a total sales amount of the transaction, minus a total discount amount due to application of the coupon.

15. The method of claim 14, wherein the commission amount is negative.

16. The method of claim 15, further comprising:
c) reimbursing the retailer to compensate for the negative commission amount.

17. The method of claim 14, further comprising:
c) transferring wirelessly an application, directed to the mobile electronic device, which when executed by the mobile electronic device, will send a notification through a user interface of the device of an opportunity to use the electronic coupon.

18. The method of claim 17, wherein the notification will be sent when the mobile device is detected to be in a bounded geographic region that includes a store of the retailer.

19. The method of claim 18, wherein detection uses GPS, a cell system tower, a beacon, or an RFID system.

20. The method of claim 14, further comprising:
c) selecting by the affiliate without prior approval of the retailer, a product covered by the coupon.

21. The method of claim 14, further comprising:
c) automatically verifying by the processing system that the offer conforms to a retailer rule, pertaining to electronic coupons usable at one or more stores of the retailer, that the processing system accesses from nontransitory computer-readable storage.

22. The method of claim 14, the contents of the electronic coupon further including:
(iv) a retailer ID, identifying the retailer.

23. The method of claim 14, further comprising:
c) authenticating validity of the electronic coupon.

24. The method of claim 14, wherein the total sales amount is based upon all products purchased during the transaction, including any covered products.

25. The method of claim 14, wherein the total sales amount is based upon all products purchased during the transaction, excluding any covered products.

26. An apparatus, comprising:
a) a mobile electronic device that includes a processing system;
b) a software application, which
(i) is wirelessly received by the device through a physical interface of the device;
(ii) is accessed by the processing system from tangible nontransitory storage of the device, and executed by the processing system;
(iii) causes the device to wirelessly receive an electronic coupon from an affiliate of a retailer, wherein the electronic coupon includes a representation of
(A) a consumer identifier (ID), identifying a consumer,
(B) an affiliate ID, identifying the affiliate, and
(C) an retailer ID, identifying the retailer, and
(D) an offer by the affiliate specifying a discount to be provided by the retailer, on a product covered by the coupon, at a store of the retailer, where goods and services are considered products, and
(iv) when the mobile device is proximate to a point-of-sale system at the store, accesses the electronic coupon from the storage, and transmits the electronic coupon through a physical interface of the device.
